(19) United States
(12) Patent Application Publication
(10) Pub. No.: US 2025/0381536 A1
(43) Pub. Date: Dec. 18, 2025

(54) FLUID TREATMENT SYSTEM AND METHOD

(71) Applicant: Three Es S.r.l., Lazzate MB (IT)

(72) Inventor: Marco SOLDO, Lazzate MB (IT)

(21) Appl. No.: 18/877,237

(22) PCT Filed: Jun. 20, 2023
(86) PCT No.: PCT/IB2023/056368

§ 371 Date: Dec. 19, 2024

(30) Foreign Application Priority Data
Jun. 21, 2022 (IT) 102022000013054

(51) Int. Cl. B01F 27/81; B01F 23/41; B01F 23/43; B01F 27/113; B01F 27/192; B01F 27/85; B01F 27/91; B01F 35/32

(52) U.S. Cl. CPC B01F 27/811; B01F 23/4105; B01F 23/43; B01F 27/113; B01F 27/192; B01F 27/85; B01F 27/91; B01F 35/3204

(57) ABSTRACT

A fluid treatment system (1), such as a turbo emulsifier, comprises a tank (2) for containing a static fluid mass. A rotation shaft (3) is rotated by a motor (4). A cavitating impeller (5) is mounted to the rotation shaft (3), inside a compartment (21) of the tank (2), so as to be immersed in the fluid mass. The impeller (5) has a pair of walls (51), a gap (53) delimited by inner faces (54) of the walls (51), and blades (56) arranged in the gap (53).

### TECHNICAL FIELD

The present invention relates to the field of fluid treatment, more in particular the field of turbo emulsion.

### BACKGROUND ART

Turbo emulsifiers are machines used to treat fluids, for example in the field of cosmetic production. The fluids to be treated include a major component in liquid form, and one or more minor components in the form of solid particles in suspension in the major component, and/or gas dispersed in the mixture.

The treatment is aimed at making the distribution of solid particles and gases in the liquid uniform, and reducing the size thereof.

Known examples of turbo emulsifiers comprise a tank for treating fluid in batches. There is therefore no flow of the fluid in input or in output of the tank while the treatment is in progress. A propeller is mounted on a shaft, both rotated by a motor, to stir the fluid, thus obtaining the effect of emulsion.

WO 2020075039 discloses a system for treating different types of fluids, in particular a cavitation reactor, which provides a continuous flow of the fluid to be treated in and out of a stator compartment. A rotor, similar to that of a closed-impeller centrifugal pump, but without suction openings, causes a cavitation in the flowing fluid.

FR 1580389 discloses a water purifier, without cavitation functions, with an impeller fixed to a rotation shaft. The upper wall of the impeller has a central opening which communicates with the inside of the rotation shaft, so as to suck air from above and introduce bubbles into the water.

US2015320053 and US2012275260 disclose examples of mixers having perforated impellers, without cavitation functions.

### SUMMARY OF THE INVENTION

An object of the present invention is to improve the efficiency of fluid treatment in batches, for example for application as a turbo emulsifier.

The Applicant has noted that the efficiency of the cavitation reactor of WO 2020075039 in treating fluids is higher than that of traditional turbo emulsifiers. However, the cavitation reactor structure of WO 2020075039 is not designed for batch operation.

The Applicant then surprisingly noted that the single impeller of the reactor of WO 2020075039 may be added to or replaced with the propeller of a turbo emulsifier, without necessarily providing a stator in which to continuously flow the fluid to be treated.

The stated object is therefore achieved by a fluid treatment system or method according to any one of the appended claims.

The system comprises a tank having a compartment shaped to contain a predetermined mass of static fluid. There is therefore no provision for fluid to flow in input or in output of the tank during treatment. A cavitation impeller, similar to that of WO 2020075039, is mounted on a rotation shaft so as to be immersed in the fluid mass.

Driving the cavitating impeller, the cavitation phenomenon may be obtained inside the tank, with advantageous effects of reducing the particle size in the fluid mass, where convective stirring motions may also be developed.

The cavitation may be facilitated and increased in intensity, despite the absence of a stator in which the fluid flows, by means of one or more of the following expedients:
increasing the rotation speed of the cavitating impeller,
increasing the pressure of the fluid in the position in which the cavitating impeller is located,
making curved blades in the cavitating impeller, rotating them with an orientation of rotation such that a concave face of the blade precedes a convex face, and
appropriately designing the radius of the cavitating impeller and the width of the internal gap.

In some embodiments, to increase the pressure of the fluid, it is possible to position the cavitating impeller at a greater depth, or to provide a second impeller, of the pumping type, for example configured to press the fluid from the top downwards, in the direction of the underlying cavitating impeller.

Further features and advantages of the invention will be recognisable by a person skilled in the art from the following detailed description of exemplary embodiments of the invention.

### BRIEF DESCRIPTION OF THE FIGURES

For a better understanding of the following detailed description, some embodiments of the invention are illustrated in the accompanying drawings, in which:

FIG. 1 schematically shows a sectional view of a fluid treatment system according to an embodiment of the invention,

FIG. 2 schematically shows a sectional view of a fluid treatment system according to an alternative embodiment of the invention,

FIG. 3 schematically shows a sectional view of a cavitating impeller of the systems of FIGS. 1 and 2, and

FIG. 4 schematically shows a sectional view of a pumping impeller of the systems of FIGS. 1 and 2.

### DETAILED DESCRIPTION

A fluid treatment system is indicated with the number 1. The system 1 is a system for the mechanical treatment of fluids, in particular a system for emulsifying a fluid, preferably a turbo emulsifier,

The system 1 comprises a tank 2 having a compartment 21 shaped to contain a predetermined amount of a static fluid mass.

In the preferred embodiment, the tank 2 has a bottom wall 22 and at least one side wall 23, for example a substantially cylindrical side wall 23, extending above the bottom wall 22. The bottom wall 22 and the side wall 23 at least partially delimit the compartment 21.

In this disclosure, with the terms above and below, or the like, it is intended to refer to a normal use position of the tank 2, whereby the weight of the fluid mass, if present in the tank 2, presses from the top downwards, on the bottom wall 22.

The fluid mass in the tank 2 is indicated as static in contrast to the case of a fluid flowing continuously in input and in output from a different type of compartment. However, other motions of the static fluid mass are permitted, such as convective motions, wave motions, or other stirring motions.

It should be noted that, when the fluid mass is present in the tank 2 in the predetermined amount, the fluid mass has a free surface 100 spaced apart from the bottom wall 22 by a predetermined height H. The tank 2, at least during use, is devoid of open channels which are in fluid communication with the compartment 21 below the level of the free surface 100 of the fluid mass, i.e., below the predetermined height H.

More in detail, in an embodiment the bottom and side walls 22, 23 of the tank 2 are completely devoid of openings, and therefore no channel is connected thereto. In such a case, the tank 2 may have an upper opening 24 for accessing the compartment 21, so as to fill and empty the compartment 21 of the fluid, before and after the treatment. Still more in detail, the tank 2 may have a top wall 25, connected to the at least one side wall 23, and the top opening 24 may be formed through the top wall 25. Alternatively, the tank 2 may lack the top wall 25, and the top opening 24 may be delimited by the at least one side wall 23.

In an alternative embodiment, the tank 2 has one or more channels (not shown) in fluid communication with the compartment 21, below the level of the free surface 100 of the fluid mass. Accordingly, the bottom wall 22 and/or the at least one side wall 23 have one or more access openings to the compartment 21, below such a level. These channels and openings may be opened before and after the treatment, to fill and empty the fluid compartment 21, or for other purposes. However, the tank 2 comprises a closing element (not shown) for each of these channels, so that, during the treatment, each channel is closed and the flow of the fluid in input or in output of the tank 2 is prevented.

In the presence of such channels, the tank 2 may or may not have a top wall 25 and/or a top opening 24, and the top opening 24 in use may or may not be closed by a lid 27.

The system 1 then comprises a rotation shaft 3, which extends mainly along a longitudinal axis A-A.

In a known manner, the rotation shaft 3 may be directly or indirectly connected to the tank 2, and is configured for rotation with respect to the tank 2, about the longitudinal axis A-A. Furthermore, the rotation shaft 3 is arranged at least partially inside the compartment 21 of the tank 2, to be at least partially immersed in the fluid mass.

The system 1 comprises a motor 4, for example an electric motor, connected to the rotation shaft 3 and configured to rotate the rotation shaft 3 with respect to the tank 2. Preferably, the motor 4 is located outside the compartment 21.

In an embodiment, the rotation shaft 3 is rotationally connected to the bottom wall 22, and protrudes from the bottom wall 22 towards the inside of the compartment 21. For example, the rotation shaft 3 may extend through a sealing bearing device 26 positioned in the bottom wall 22.

In another embodiment, the rotation shaft 3 extends at least in part through the upper opening 24 of the tank 2. In such a case, the rotation shaft 3 is not necessarily supported by the tank 2, but by any support structure which may be selected by a person skilled in the art.

In a further embodiment, the rotation shaft 3 comprises a portion inside the compartment 21, a portion outside the compartment 21, fixed to a portion of the motor 4, and a magnetic joint which couples the inner portion and the outer portion together through a wall of the tank 2.

The invention may however also be achieved with other different possible positioning of the shaft 3, and shafts 3 with non-vertical orientations may also be allowed.

The system 1 comprises a first impeller 5, also referred to as a cavitating impeller, mounted to the rotation shaft 3. The first impeller 5 is thus configured to rotate with respect to the tank 2 about the longitudinal axis A-A, together with the shaft 3, when the shaft 3 is rotated.

The first impeller 5 has at least one pair of walls 51, spaced from each other along the direction of the longitudinal axis A-A. Each wall 51 is surrounded by a peripheral free edge 52, spaced from the longitudinal axis A-A in a radial direction. Each wall 51 may be substantially planar, or funnel-shaped.

The first impeller 5 has at least one gap 53 between two consecutive walls 51. More gaps 53 may be present if there are more than two walls 51, but in the following reference will be made to a single gap 53 for the sake of simplicity.

More in detail, each wall 51 has an inner face 54, facing the gap 53 and transverse to the direction of the longitudinal axis A-A, and an outer face 55 opposite the inner face 54. The inner faces 54 of consecutive walls 51 face each other and delimit the gap 53 in the direction of the longitudinal axis A-A.

The gap 53 is accessible by passing between the peripheral edges 52 of the walls 51. Instead, each wall 51 of the first impeller 5 is devoid of open access openings to the gap 53. Therefore, the fluid cannot access the gap 53 through openings which are formed through the walls 51.

More in detail, each wall 51 may be entirely devoid of openings, or may be provided with one or more openings which in use are closed by respective closing elements.

The impeller 5 has a plurality of blades 56 arranged in the gap 53. The blades 56 extend between a central portion of the impeller 5, close to the longitudinal axis A-A, and a peripheral portion of the impeller 5. The blades 56 divide the gap 53 into compartments, which are distributed circumferentially around the longitudinal axis A-A and each extend between the central portion and the peripheral portion of the impeller 5.

In the preferred embodiment, each blade 56 has a concave face and a convex face, opposite the concave face. Furthermore, the motor 4 is configured to rotate the shaft 3 in a rotation direction such that the concave face precedes the convex face. This rotational orientation promotes cavitation, and thus allows cavitation to be obtained with lower rotation speeds and/or lower fluid pressures.

In another embodiment, a rotation direction is still allowed so that the convex face precedes the concave face. Still alternatively, the blades 56 may extend substantially straight, radially away from the longitudinal axis A-A, and thus may be devoid of concave or convex faces.

The first impeller 5 is arranged inside the compartment 21 of the tank 2, so as to be immersed in the fluid mass, when present in the tank 2. In particular, the first impeller 5 is arranged below the level of the free surface 100, i.e., it is positioned below the aforementioned predetermined height.

It should be noted that the first impeller 5, being immersed in the fluid, is subjected to a pressure by the fluid. When the shaft 3 is stopped, the fluid pressure at the first impeller 5 assumes a predetermined base value. The base value of the pressure is determined by the depth of the first impeller 5 with respect to the free surface 100, and by air pressure conditions above the free surface 100.

In an embodiment, for example when an upper opening 24 is included, the air above the free surface 100 is at atmospheric pressure. Therefore, the base value is greater than one atmosphere, in terms of absolute pressure, i.e., greater than zero in terms of relative pressure.

In another embodiment, the tank 2 is configured to be hermetically closed, and the system 1 may comprise pressurization or depressurization means (of known type, not illustrated) configured to increase or decrease the air pressure above the free surface 100, with respect to the atmospheric pressure. This also affects the base pressure value on the first impeller 5. In many known applications, the system 1 is vacuum operated so as not to introduce air into the fluid.

When the shaft 3 is rotated, the pressure of the fluid mass may change with respect to the base value, at least locally. In particular, the rotation of the first impeller 5 determines a decrease in pressure inside the gap 53, which promotes cavitation. Instead, in an embodiment, the pressure outside the gap 53 increases or remains substantially equal to the base value even when the shaft 3 is rotated.

In another embodiment, to influence the pressure value, the system 1 comprises a second impeller 6, different from the first impeller 5. The second impeller 6 is arranged inside the compartment 21 of the tank 2, so as to be immersed in the fluid mass, when present in the tank 2.

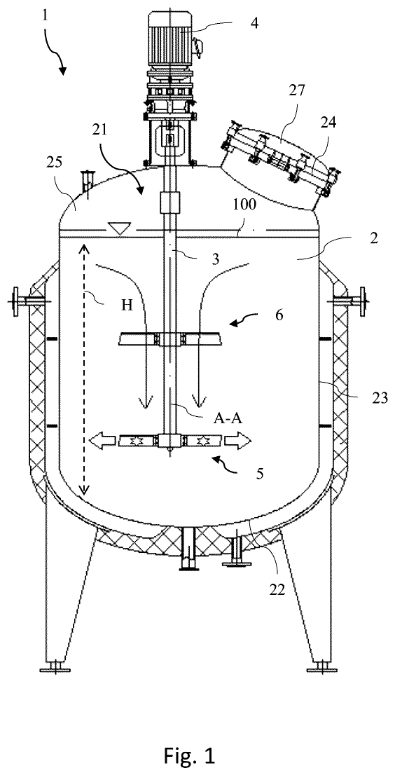

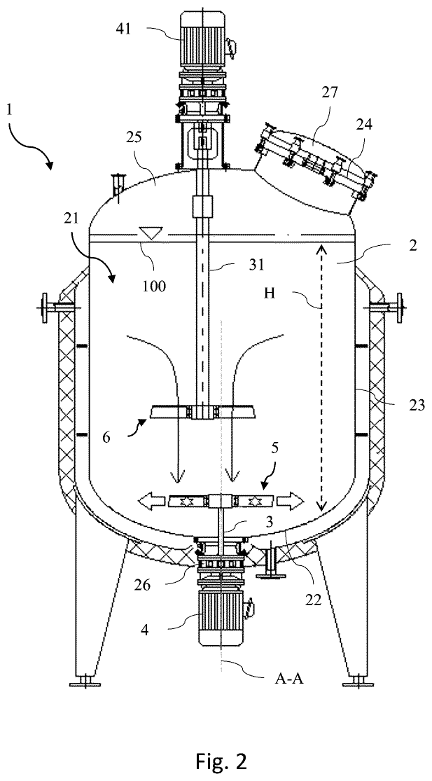

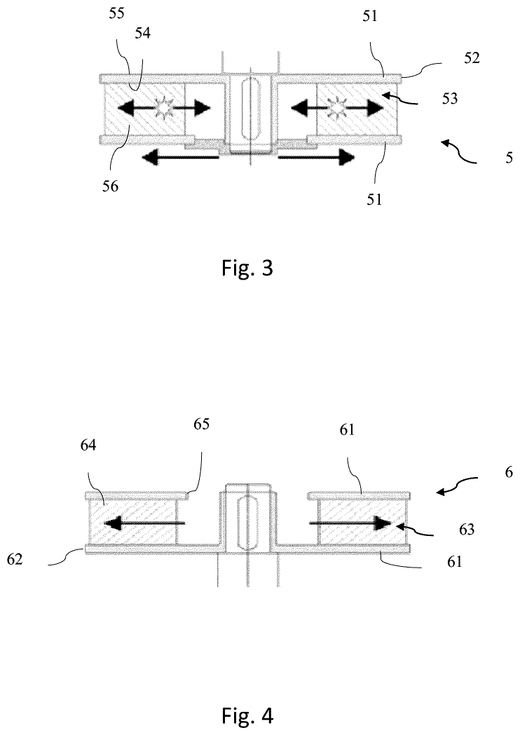

In FIG. 1, the two impellers 5, 6 are mounted to the same rotation shaft 3. In FIG. 2, the second impeller 6 is mounted on its own rotation shaft 31, driven by its own motor 41, distinct from those to which the first impeller 5 is mounted.

Preferably, the second impeller 6 is a pumping impeller configured, when rotated, to move the fluid, preferably to cause a convective motion in the fluid mass.

In the preferred embodiment, the second impeller 6 is a closed centrifugal impeller. In such a case the second impeller 6, similarly to the first impeller 5, has two walls 61, spaced in the direction of the longitudinal axis A-A and surrounded by peripheral free edges 62. A gap 63 is present between the walls 61, delimited by inner faces of the walls 61. Blades 64 are arranged in the gap 63. However, unlike the first impeller 5, one of the walls 61 of the second impeller 6 has a central suction opening 65.

However, other types of pumping impellers known to the person skilled in the art are also allowable as second impeller 6. Furthermore, the possibility of several pumping impellers 6 and/or several cavitating impellers 5 in the same system 5 is allowed.

The second impeller 6 is configured, when rotated, to move the fluid mass so as to generate an increased pressure value of the fluid mass at the first impeller 5, in particular outside the first impeller 5. The increased pressure value is greater with respect to the base pressure value.

To such an end, in the preferred embodiment the second impeller 6 is positioned higher than the first impeller 5, and is configured, when rotated, to press at least a portion of the fluid mass downwards.

It should be noted that the motor 4 is configured to rotate the rotation shaft 3 at a predetermined speed, such that the first impeller 5 causes a cavitation phenomenon in the fluid mass, at the predetermined pressure to which the first impeller 5 is subjected, also considering the pressure optionally developed by the second impeller 6.

More in detail, with a fixed geometry of the first impeller 5, and in particular the shape and dimensions of the blades 56, but also of the walls 51 and of the gap 53, and with a fixed pressure outside the first impeller 5, there is a limit value of rotation speed such as to determine the triggering of the cavitation. The rotation speed set by the motor 4 is therefore at least equal to such a limit value.

From the above, it is understood that the speed limit value may be reduced if the pressure outside the first impeller 5 is raised, for example by the second impeller 6, or by increasing the depth of the first impeller 5, or by pressurizing the tank 2. Furthermore, the speed limit value may be reduced by making curved blades 56 and rotating them so that the concave face precedes the convex face.

Reducing the limit speed means that the same cavitation effect may be achieved with a lower speed of the shaft 3, and therefore with lower energy consumption, or that at the same speed of the shaft 3 the cavitation effect may be intensified.

Additionally or alternatively to the pumping effect, the second impeller 6 may be configured to mechanically treat the fluid by shear stress lamination. The lamination and the pumping effect may be achieved by a same stage of the second impeller 6, or by separate stages.

From what has been described so far, the methods of use are evident of the system 1 in a fluid treatment process. In particular, it is necessary to fill the compartment 21 of the tank 2 with a static mass of a fluid to be treated, such as to submerge the first impeller 5, and if included also the second impeller 6.

Then the motor is driven to overcome the limit speed, so that the first impeller 5 causes a cavitation phenomenon in the fluid mass. Lastly, the fluid mass which has been thus treated is removed from the tank 2.

During the fluid treatment, i.e., as long as the shaft 3 is rotating above the limit speed, no fluid is inserted and/or removed from the tank 2.

Obviously, a person skilled in the art will be able to make numerous modifications to the variants set forth above, without thereby abandoning the scope of protection defined by the appended claims.

1. Fluid treatment system, comprising:
a tank having a compartment shaped to contain a predetermined mass of static fluid, to reach a predetermined height from a bottom wall of the tank,
a rotation shaft, at least partially inside the compartment of the tank, the rotation shaft extending mainly along a longitudinal axis,
a motor configured to rotate the rotation shaft with respect to the tank,
a first impeller mounted to the rotation shaft, inside the compartment of the tank below the predetermined height,
wherein the first impeller has:
a pair of walls, each wall being surrounded by a peripheral edge spaced apart from the longitudinal axis, each wall having an inner face transverse to the direction of the longitudinal axis, the inner faces of the two walls facing each other,
a gap delimited by the inner faces of the walls,
a plurality of blades arranged in the gap,
wherein each wall of the first impeller is devoid of open access openings to the gap.

2. System according to claim 1, wherein the tank is devoid of open channels which are in fluid communication with the compartment below the predetermined height.

3. System according to claim 1, comprising a second impeller, preferably mounted to the rotation shaft, placed inside the compartment of the tank below the predetermined height,
wherein the second impeller is a pumping impeller configured, when rotated and when a fluid mass is present in the compartment, to generate an increased pressure value of the fluid mass at the first impeller, which is greater with respect to a base pressure value of the fluid mass at the first impeller when the second impeller is stopped.

4. System according to claim 3, wherein the second impeller is positioned higher than the first impeller, and is configured, when rotated and when a fluid mass is present in the compartment, to press at least a portion of the fluid mass downwards.

5. System according to claim 1, wherein the rotation shaft is rotationally connected to the bottom wall of the compartment and protrudes from the bottom wall towards the inside of the compartment.

6. System according to claim 1, wherein:
the tank has an upper opening for access to the compartment, and
the rotation shaft extends at least in part through the upper opening.

7. System according to claim 1, wherein:
the blades of the impeller extend substantially straight, in a radial direction away from the longitudinal axis, or
the blades of the impeller each have a concave face and a convex face, and the motor is configured to rotate the rotation shaft so that the concave face precedes the convex face, or,
the blades of the impeller each have a concave face and a convex face, and the motor is configured to rotate the rotation shaft so that the convex face precedes the concave face.

8. Process for treating fluids by means of a system according to claim 1, comprising, in order:
filling the compartment of the tank with a static mass of a fluid to be treated,
driving the motor so that the first impeller causes a cavitation phenomenon in the fluid mass,
removing the fluid mass from the tank.
